(19) United States
(12) Patent Application Publication
(10) Pub. No.: US 2011/0183309 A1
(43) Pub. Date: Jul. 28, 2011

(54) METHOD AND APPARATUS FOR STIMULATING MEMORY IN ALZHEIMER'S PATIENTS

(76) Inventor: Haley Ochoa, Tucson, AZ (US)

(21) Appl. No.: 13/012,667

(22) Filed: Jan. 24, 2011

Related U.S. Application Data
(60) Provisional application No. 61/297,677, filed on Jan. 22, 2010.

(51) Int. Cl. G09B 19/00

(52) U.S. Cl. 434/365

(57) ABSTRACT

A method is presented for displaying images on a station having a visual display device, a data input device, and a computing device in communication with the display device, the computing device having a processor and a non-transitory computer readable medium in communication with the processor, and wherein the computer readable medium has (N) personalized images and (K) nominal image responses stored thereon, wherein each of the (N) personalized images are associated with at least one of the (K) nominal image responses. The method includes selecting an (i)th personalized image for display and displaying, using the visual display device, the (i)th personalized image and (j) nominal image responses. The method further includes receiving, via the data input device a user response.

### CROSS REFERENCE TO OTHER APPLICATIONS

This application claims the benefit of and priority from U.S. Provisional Patent Application No. 61/297,677 filed on Jan. 22, 2010, entitled “Method and Apparatus for Improved Memory in Alzheimer Patients,” the disclosure of which is hereby incorporated by reference in its entirety.

### FIELD OF REFERENCE

The present application relates to methods and devices for improving memory and, more particularly, to methods and devices for improving memory in Alzheimer's patients.

### BACKGROUND

Alzheimer's disease, also called Alzheimer disease, senile dementia of the Alzheimer type, and primary degenerative dementia of the Alzheimer's type, is the most common form of dementia. It is an incurable, degenerative, and terminal disease that is most often diagnosed in people over 65 years of age. Although Alzheimer's disease is unique for every individual, there are many common symptoms including the inability to acquire new memories. As the disease advances, the symptoms includes confusion, irritability, aggression, mood swings, language breakdown, and long-term memory loss. Over time, bodily functions also breakdown, which ultimately leads to death of the patient.

The cause of Alzheimer's disease is not well understood and, as of today, there are no treatments to delay or halt the progression of the disease. Because Alzheimer's disease is incurable and degenerative, treatment mainly consists of caregiving to manage the symptoms of the disease. During early to moderate stages of the disease, modifications to an individual's living environment can help an Alzheimer's patient live as independently as possible and reduce the burden on the primary caregiver. Examples of such modifications are the adherence to simplified routines and the labeling of household items which helps cue the patient. What is needed is a method and device to assist Alzheimer's patients in remembering associations as well as daily tasks.

### SUMMARY

A method is presented for displaying images on a station having a visual display device, a data input device, and a computing device in communication with the display device, the computing device having a processor and a non-transitory computer readable medium in communication with the processor, and wherein the computer readable medium has (N) personalized images and (K) nominal image responses stored thereon, wherein each of the (N) personalized images are associated with at least one of the (K) nominal image responses, wherein (N) and (K) are greater than or equal to 1. The method includes selecting an (i)th personalized image for display, wherein (i) is initially set to 1, and wherein (i) is less than or equal to (N) and displaying, using the visual display device, the (i)th personalized image and (j) nominal image responses, wherein (i) is initially set to 1, and wherein (i) is less than or equal to (N). The method further includes receiving, via the data input device a user response.

In another embodiment, a method is presented for displaying images on a station having a visual display device, a data input device, and a computing device in communication with the display device, the computing device including a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1. The method includes selecting (q) personalized images for display, wherein (q) is less than or equal to (N) and displaying, using the visual display device the (q) personalized images and (j) nominal image responses, wherein (j) is greater than or equal to (q), wherein (j) is less than or equal to (K), wherein each of the (q) personalized images are associated with one of the (j) nominal image responses. The method further includes, for each of the (q) personalized images, receiving, via the data input device, a user response comprising an identification of one of the (j) nominal image responses, comparing the user response with the associated nominal image response, and when the user response is the associated nominal image response, setting (i) equal to (i+1) and repeating said selecting, said displaying, said receiving, and said comparing.

In yet another embodiment, an article of manufacture is presented having a non-transitory computer readable medium including computer readable program code encoded therein to display images on a station comprising a visual display device, a data input device, and a computing device in communication with the display device, the computing device having a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1. The computer readable program code includes a series of computer readable program steps to effect selecting an (i)th personalized image for display, wherein (i) is initially set to 1, and wherein (i) is less than or equal to (N) and displaying, using the visual display device, the (i)th personalized image and (j) nominal image responses, wherein (j) is greater than or equal to 1, wherein (j) is less than or equal to (K), wherein the (i)th personalized image is associated with one of the (j) nominal image responses, wherein the associated (j) nominal image response is the correct response. The computer readable program code further includes a series of computer readable program steps to effect receiving, via the data input device, a user response.

In yet another embodiment, an article of manufacture is presented comprising a non-transitory computer readable medium comprising computer readable program code encoded therein to display images on a station having a visual display device, a data input device, and a computing device in communication with the display device, the computing device including a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1. The computer readable program code comprising a series of computer readable program steps to effect selecting (q) personalized images for display, wherein (q) is less than or equal to (N) and displaying, using the visual display device the (q) personalized images and (j) nominal image responses, wherein (j) is greater than or equal to (q), wherein (j) is less than or equal to (K), wherein each of the (q) personalized images are associated with one of the (j) nominal image responses. Further, the computer readable program code comprising a series of computer readable program steps to effect, for each of the (q) personalized images, receiving, via the data input device, a user response comprising an identification of one of the (j) nominal image responses, comparing the user response with the associated nominal image response, and when the user response is the associated nominal image response, setting (i) equal to (i+1) and repeating said selecting, said displaying, said receiving, and said comparing.

In yet another embodiment, a computer program product encoded in a non-transitory computer readable medium and useable with a programmable computer processor is presented. The computer program product is to display images on a station comprising a visual display device, a data input device, and a computing device in communication with the display device, the computing device having a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1. The computer program product comprises computer readable program code which causes the programmable processor to select an (i)th personalized image for display, wherein (i) is initially set to 1, and wherein (i) is less than or equal to (N) and to display, using the visual display device the (i)th personalized image and (j) nominal image responses, wherein (j) is greater than or equal to 1, wherein (j) is less than or equal to (K), wherein the (i)th personalized image is associated with one of the (j) nominal image responses, wherein the associated (j) nominal image response is the correct response. The computer program product further comprises computer readable program code which causes the programmable processor to receive, via the data input device, a user response.

In yet another embodiment, a computer program product encoded in a non-transitory computer readable medium and useable with a programmable computer processor is presented. The computer program product is to display images on a station comprising a visual display device, a data input device, and a computing device in communication with the display device, the computing device comprising a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1. The computer program product comprises computer readable program code which causes the programmable processor to select (q) personalized images for display, wherein (q) is less than or equal to (N), and to display, using the visual display device the (q) personalized images and (j) nominal image responses, wherein (j) is greater than or equal to (q), wherein (j) is less than or equal to (K), wherein each of the (q) personalized images are associated with one of the (j) nominal image responses. The computer program product further comprises computer readable program code which, for each of the (q) personalized images, causes the programmable processor to receive, via the data input device, a user response comprising an identification of one of the (j) nominal image responses, to compare the user response with the associated nominal image response, and, when the user response is the associated nominal image response, setting (i) equal to (i+1) and repeating said selecting, said displaying, said receiving, and said comparing.

In yet another embodiment, a method is provided. The method comprises providing (N) personalized images and (K) nominal image responses, wherein each of the (N) personalized images is associated with at least one of the (K) nominal image responses, wherein (N) and (K) are greater than or equal to 1. The method further includes displaying the (i)th personalized image and (j) nominal image responses, wherein the (i)th personalized image is associated with one of the (j) nominal image responses, wherein (i) is greater than or equal to 1, wherein (i) is less than or equal to (N), wherein (j) is greater than or equal to 1, wherein (j) is less than or equal to (K). The method further includes receiving a selection of one of the (j) nominal image responses and comparing the selected nominal image response with the associated nominal image response.

### BRIEF DESCRIPTION OF THE DRAWINGS

Implementations of the invention will become more apparent from the detailed description set forth below when taken in conjunction with the drawings, in which like elements bear like reference numerals.

FIG. 1 summarizes an exemplary method of displaying images according to the Applicant's invention;

FIG. 2 depicts a block diagram of Applicant's apparatus for using with the present invention;

FIG. 3 depicts the computer system of FIG. 2 being used by a user according to the present invention;

FIG. 4 illustrates a plurality of computer systems being interconnected via a network to a central server.

FIG. 5 depicts an exemplary block diagram of a display presenting Applicant's invention; and

FIG. 6 depicts an exemplary block diagram of a display presenting Applicant's invention.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicant's invention comprises a device and method of presenting images to a user, such as and without limitation an Alzheimer's patient. Moreover applicant's invention allows the images to be personalized for the user such that the images reinforce the user's memory of relationships.

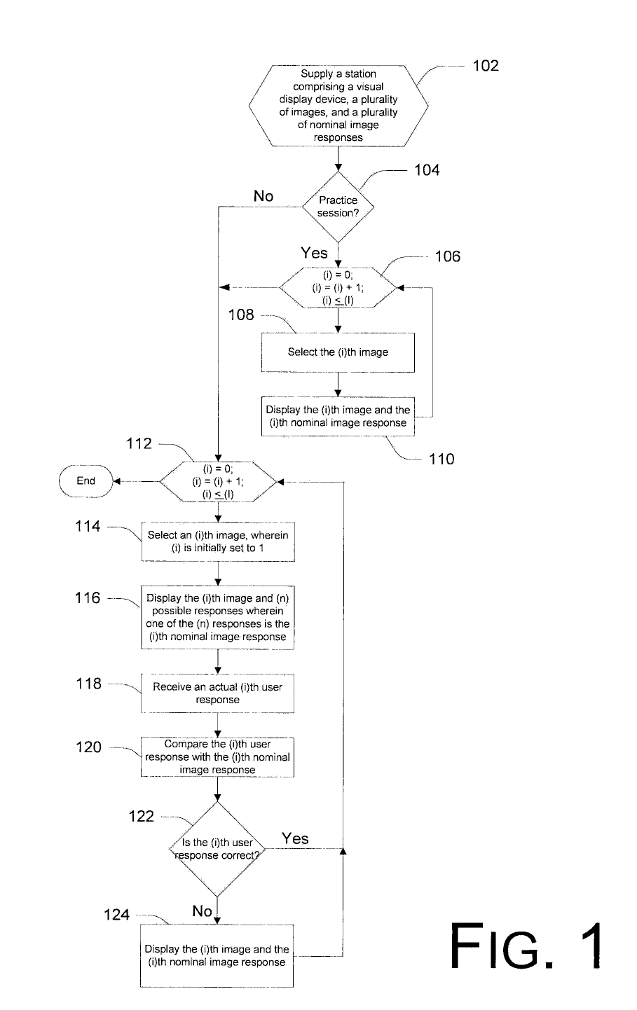

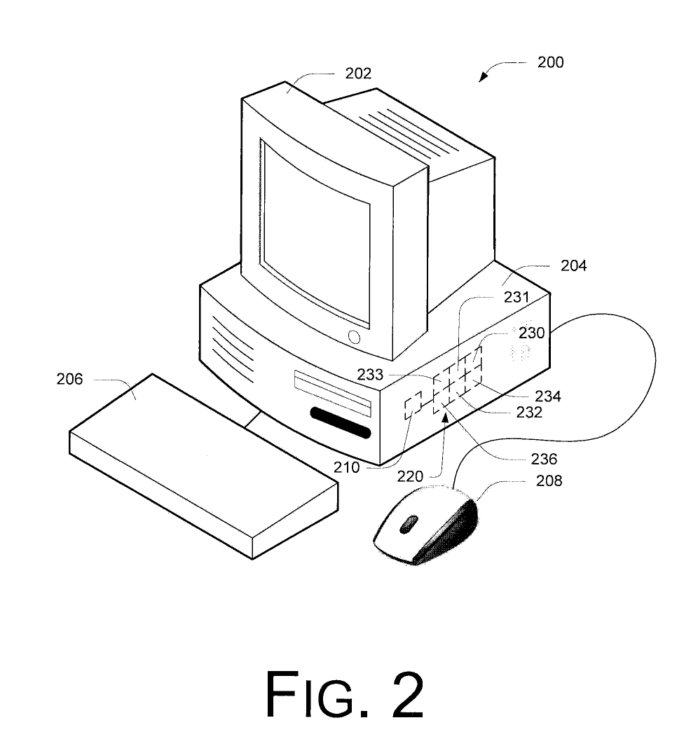

Turning now to FIG. 1, a block diagram of an exemplary method of displaying images according to the present invention is depicted. In the illustrated embodiment of FIG. 1, a station, such as station 200 (FIG. 2) comprising a visual display device, a plurality of images, and a plurality of nominal image responses are presented.

The images provided are personal to the user of station 200. In certain embodiments, the images are of an individual the user knows, such as, and without limitation, family and friends or even pets. In certain embodiments, the images are of places the user frequents or other images of places associated with the user, such as, and without limitation, the local grocery store, pharmacy, or the beauty salon, the user's home, the town the user lives in, or the town that a family member lives in. In certain embodiments, the images are of items which can indicate an activity, such as, and without limitation, a toothbrush and toothpaste, breakfast foods, or a shower. In other embodiments, the images are of activities or events, such as, and without limitation, the user feeding a cat, or the user with a grandchild dressed in a Halloween costume.

The nominal image responses provided relate to the images. Thus, in certain embodiments, the nominal image responses are names of people, locations, or places. In other embodiments, the nominal image responses are relationships, such as, and without limitation, son, daughter, grandchild, or friend. In other embodiments, the nominal image responses are the name of an activity such as, and without limitation, “feed Fluffy” or “brush teeth.” In certain embodiments, the nominal image responses are a confirmation that the activity or appointment indicated by the associated image has occurred. Thus, in such embodiments, where the image is of a toothbrush and toothpaste, the nominal image response is a confirmation that the user has brushed his/her teeth.

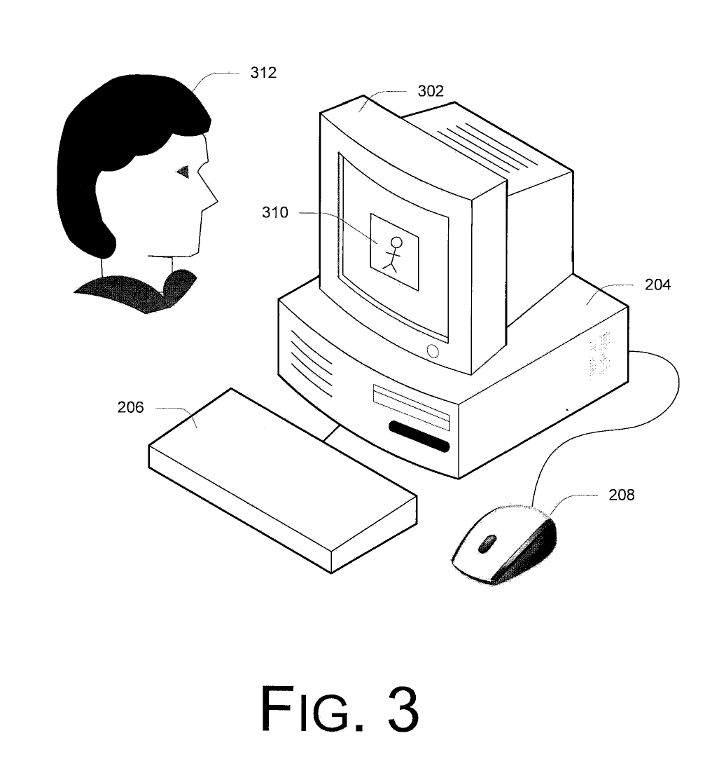

In certain embodiments, the images and nominal image responses provided are preloaded onto station 200. In other embodiments, the images and nominal image responses are stored on a server, such as discussed in relation to FIG. 3. In such embodiments, the images and nominal image responses may be provided by the user. In other such embodiments, the images and nominal image responses may be provided by someone other than the user.

In the illustrated embodiment of FIG. 1, if the user is practicing, the (i)th image is displayed on a display device, such as display device 202 (FIG. 2) along with the (i)th nominal image response, wherein (i) initially equal to one and (i) is less than or equal to the total number of images (I), as indicated by blocks 104, 106, 108, and 110. In certain embodiments, only a subset of the total number of images (I) are displayed. Thus, in such embodiments (i) is initially equal to one and (i) is less than or equal to (K), wherein (K) is some number less than the total number of images (I). In such embodiments, the subset shown may be only the newly added images or images that the user is having particular difficulty with.

In certain embodiments (I) is equal to ten (10) and (K) is equal to some number less than ten (10). In certain embodiments (I) is equal to one hundred (100) and (K) is equal to some number less than one hundred (100). In certain embodiments (I) is equal to some number greater than one hundred (100). In certain embodiments, (I) is equal to some number less than ten (10).

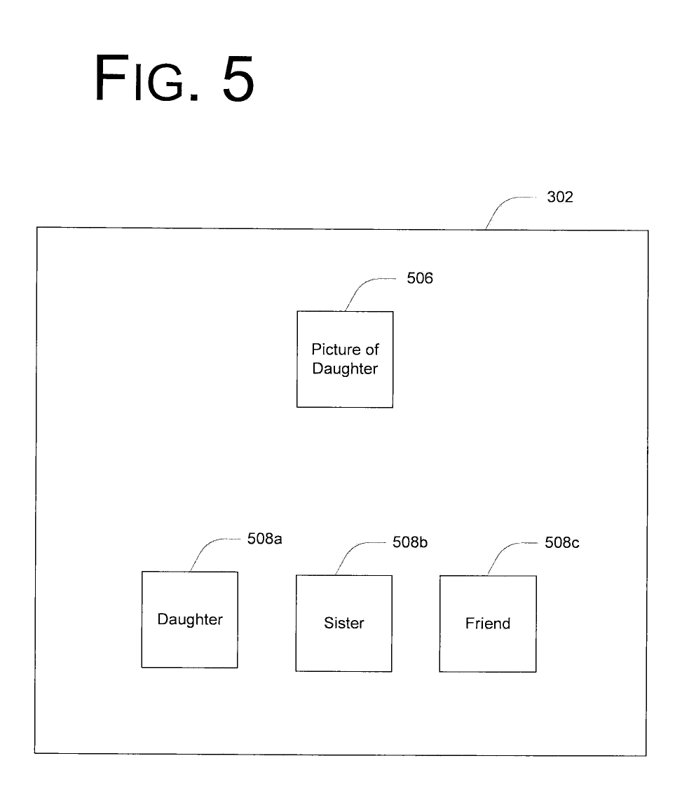

FIG. 5 presents an exemplary block diagram of display device 302 displaying image 506 along with nominal image responses 508a, 508b, and 508c. The (i)th nominal image response relates in some manner to the (i)th image. Thus, by way of example and not limitation, if the (i)th image is of the user's daughter, (i) th nominal image response may be the daughter's name or the relationship. By seeing each image displayed with the correct nominal image response the user can study the pictures and responses and see what new images have been added, if any.

In the illustrated embodiment of FIG. 1, If the user is not practicing, or has finished doing so, the (i)th image is selected, where (i) is initially equal to one and (i) is less than or equal to the total number of images (I), as indicated by blocks 112 and 114. In certain embodiments, (i) is less than or equal to (K) where (K) is some number less than (I). In such embodiments, the user is therefore shown less then the total number of images. In certain embodiments, the subset of images shown to the user may all be in the same category such as, and without limitation, “friends,” “places,” or “things to do.”

As indicated by block 116, the (i)th image is displayed to the user along with (n) possible responses, where one of the (n) responses is the (i)th nominal image response. In certain embodiments, (n) is some number less than (I). The (i) th user response is then received, as indicated by block 118, where the (i)th user response is one of the (n) responses that the user believes matches with the (i)th image.

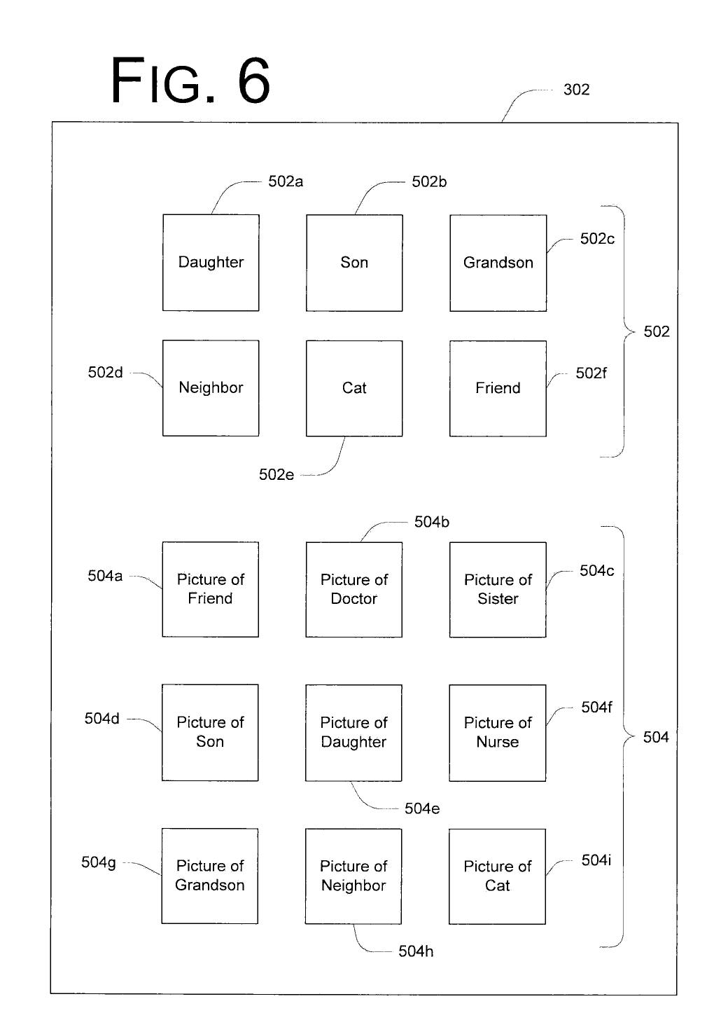

In certain embodiments, multiple images may be displayed to the user along with multiple results, such as depicted in FIG. 6. In the illustrated embodiment of FIG. 6, display 302 presents images, such as images 502a-502f along with nominal image responses 504a-504i. In such an embodiment, the user would match each image with a nominal image response. In certain embodiments, the number of nominal image responses may be equal to the number of images displayed. In other embodiments, the number of images displayed may be less than or greater than the number of nominal images displayed. In certain embodiments, where the user has matched the image with an incorrect nominal image response, the user is alerted to the error. In such embodiments, the alert is audible and may include an error sound or a prerecorded verbal notification that the user has made a mistake. In other such embodiments, the alert is visual and may include highlighting the incorrect match or a written statement that the user has made a mistake.

In the illustrated embodiment of FIG. 1, the (i)th user response is then compared with the (i)th nominal image response, as indicated by block 120. If the (i)th user response and the (i)th nominal image response match, (i) is incremented by unity and blocks 114-122 are repeated. If not, then the (i)th image and the (i)th image response are displayed to the user, as indicated by block 124, and (i) is then incremented by unity and blocks 114-122 repeated.

In certain embodiments, where the (i)th image is of an activity or appointment that is suppose to occur, the (i)th nominal image response match may be confirmation that the activity or appointment has occurred. In such embodiments, a reminder may be provided to the user if the user has not confirmed that the activity or appointment has occurred within a certain amount of time. In such embodiments, the reminder is visual and may comprise a written message to the user. In other embodiments, the reminder is audible and may include an alarm or recorded voice message reminding the user to perform the task. In such embodiments, the voice message may be recorded by a friend or family member of the user.

In certain embodiments, rather than displaying the (i)th image and the (i) th nominal image response, as indicated by block 124, the (i)th image is displayed with (n−1) responses. In such an embodiment, the user would then try again to select the correct response. In yet other embodiments, the (i)th image is displayed with another (n) responses. In certain embodiments, the user has a choice of whether to have the (i)th image displayed with the (i)th nominal image response or to try selecting the proper response again.

In certain embodiments, the (i)th image may be shown with a time, thus acting as a personalized calendar. In such embodiments, the (i)th image may be a picture of the user's doctor and the time may be listed as “2:00 pm,” thereby reminding the user that the user has a doctor's appointment at 2 pm. In certain embodiments, multiple images may be shown at once. By way of example and not limitation, an image of the user's doctor along with the front of the doctor's clinic might be displayed with the time, thereby reminding the user both of the appointment and of the location. In certain embodiments, the calendar feature may be used to remind the user of daily activities. Thus, in such an embodiment, a picture of breakfast foods on the user's china may be displayed along with the time to remind the user to eat breakfast at that time.

In certain embodiments, individual blocks described above may be combined, eliminated, or reordered.

In certain embodiments, computer readable program code, such as computer readable program code 236 (FIG. 2), are encoded in computer readable medium, such as computer readable medium 230 (FIG. 2), wherein those computer readable program code are executed by a processor, such as processor 204 (FIG. 2), to perform one or more of the blocks 102, 104, 106, 108, 110, 112, 114, 116, 118, 120, 122, and 124 recited in FIG. 1.

In yet other embodiments, the invention includes computer readable program code residing in any other computer program product, where those computer readable program code are executed by a computer external to, or internal to, a computing system to perform one or more of the 102, 104, 106, 108, 110, 112, 114, 116, 118, 120, 122, and 124 recited in FIG. 1. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

Turning to FIG. 2, Applicant's test station 200 for use with the present invention is illustrated. In the illustrated embodiment of FIG. 2, the station comprises a computing device 204, a visual display device 202, and data input device, such as for example and without limitation, a keyboard 206 and/or a mouse 208. Computing device 204 comprises a programmable processor 204, a computer readable medium 220, and computer readable program code 230 encoded in the computer readable medium 220. In certain embodiments, computing device 204, visual display device 202, and data input device are combined into a single hand-held device.

In the illustrated embodiment of FIG. 2, station 200 further comprises a plurality of images 231 encoded in computer readable medium 230, a plurality of nominal image responses 234 encoded in computer readable medium 230 wherein a nominal object response is associated with each test image comprising the plurality of images 231, a plurality of designated times 233 encoded in computer readable medium 230, and a calendar 232 encoded in computer readable medium 230.

In certain embodiments, visual display device 202 comprises a liquid crystal display (LCD) display, or a plasma display. In other embodiments, visual display device 202 comprises a video projector and screen.

In certain embodiments, data input device 206 comprises a touch screen. In such embodiments, by way of example and not by way of limitation, a test subject may trace a shape or path shown in an image on visual display device 202 using a stylus or a finger. In certain embodiments, data input device comprises a receiver capable of receiving voice commands. In such embodiments, by way of example and not by way of limitation, a user's vocalized response to the image on visual display device 202 may be received by a microphone.

In certain embodiments, computer system 200 includes an audio component. In such an embodiment, the test subject may listen to instructions and provide test responses using a microphone.

FIG. 3 illustrates a user 300 using the test station of FIG. 2. In the illustrated embodiment of FIG. 3, visual display device 202 displays an image 310 in accordance with the present invention. After viewing image 310, user 300 can input a response using keyboard 206 or mouse 208.

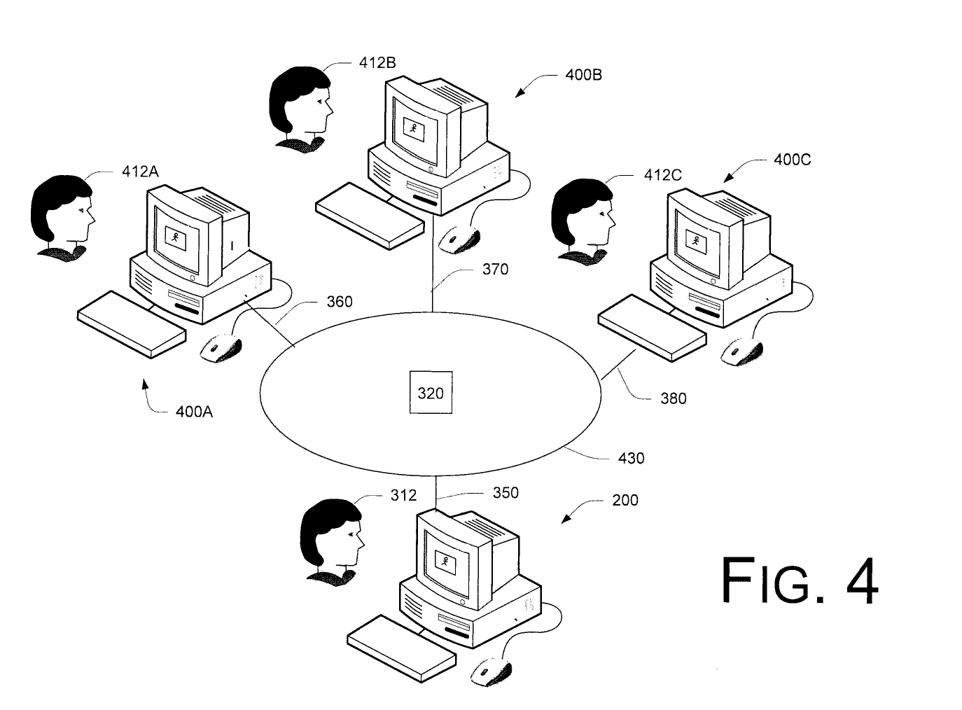

FIG. 4 shows station 200 interconnected with computer systems 400A, 400B, and 400C via communication fabric 430. In the illustrated embodiment of FIG. 4, computer systems 400A, 400B, and 400C communicate with station 200 through a data communication fabric 430. In certain embodiments, fabric 430 comprises one or more data switches 320.

Station 200 is interconnected with fabric 430 via communication link 350. Computer system 400A is interconnected with fabric 430 via communication link 360. Computer system 400B is interconnected with fabric 430 via communication link 370. Computer system 400C is interconnected with fabric 430 via communication link 380.

In certain embodiments, one or more of communication links 350, 360, 370, and/or 380 utilize a Small Computer Systems Interface (“SCSI”) communication protocol running over a Fibre Channel (“FC”) physical layer. In certain embodiments, one or more of communication links 350, 360, 370, and/or 380, utilize other communication protocols, such as Infiniband, Ethernet, or Internet SCSI (“iSCSI”).

In certain embodiments, computer systems 400A, 400B, and 400C are disposed in different locations from station 200. For example and without limitation, one or more of computer systems 400A, 400B, and 400C may be located at a residence of a friend or family member, a physicians office, a hospital, a work place, and the like. In certain embodiments, each of computer systems 400A, 400B, and 400C are disposed in different buildings, city, states, or countries. In such an embodiment, users 412A, 412B, and 412C can operate computer systems 400A, 400B, and 400C, respectively, independently of each other and independently of user 312 at station 200, i.e. upload different images and nominal responses to be displayed to user 312 at station 200, or to selectively provide feedback on how user 312 is performing. Thus, by way of example and not limitation, if an individual patient suffers from Alzheimer's, they can access a personalized memory test at station 200, which may be located in their house. Their child, living elsewhere, and their grandchild, residing at college, can upload images and nominal responses for the person to match utilizing computer systems 400A and 400B, respectively. These images and nominal responses may be stored locally on station 200 or on a server accessible by station 200 and computing systems 400A, 400B, and 400C. Furthermore, the patient's doctor can review the results of the patient's performance at computer system 400C, located in the doctor's office, thereby allowing the doctor to monitor the progression of the patient's illness without requiring the patient to travel to the doctor's office.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method of displaying images on a station comprising a visual display device, a data input device, and a computing device in communication with the display device, the computing device comprising a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1, the method comprising:
selecting an (i)th personalized image for display, wherein (i) is initially set to 1, and wherein (i) is less than or equal to (N);
displaying, using the visual display device:
the (i)th personalized image; and
(j) nominal image responses, wherein (j) is greater than or equal to 1, wherein (j) is less than or equal to (K), wherein the (i)th personalized image is associated with one of the (j) nominal image responses, wherein the associated (j) nominal image response is the correct response; and
receiving, via the data input device, a user response.

2. The method of claim 1, further comprising setting (i) equal to (i+1) and repeating said selecting, said displaying, and said receiving.

3. The method of claim 1, further comprising comparing the user response with the correct response.

4. The method of claim 3, further comprising:
when the user response is the same as the correct response, setting (i) equal to (i+1) and repeating said selecting, said displaying, said receiving, and said comparing; and
when the user response is not the same as the correct response, displaying, on the visual display device, the correct response.

5. The method of claim 1, further comprising receiving the (i)th personalized image and an associated nominal image response.

6. The method of claim 1, wherein the (i)th personalized image is of a future action, wherein the correct response is an affirmation of the occurrence of the future action, wherein the method further comprises when the user response is not received within a predetermined amount of time, providing a reminder.

7. A method of displaying images on a station comprising a visual display device, a data input device, and a computing device in communication with the display device, the computing device comprising a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1, the method comprising:
selecting (q) personalized images for display, wherein (q) is less than or equal to (N);
displaying, using the visual display device:
the (q) personalized images; and
(j) nominal image responses, wherein (j) is greater than or equal to (q), wherein (j) is less than or equal to (K), wherein each of the (q) personalized images are associated with one of the (j) nominal image responses;
for each of the (q) personalized images:
receiving, via the data input device, a user response comprising an identification of one of the (j) nominal image responses;
comparing the user response with the associated nominal image response; and
when the user response is the same as the associated nominal image response, setting (i) equal to (i+1) and repeating said selecting, said displaying, said receiving, and said comparing.

8. A method comprising:
providing (N) personalized images;
providing (K) nominal image responses, wherein each of the (N) personalized images is associated with at least one of the (K) nominal image responses, wherein (N) and (K) are greater than or equal to 1;
displaying the (i)th personalized image and (j) nominal image responses, wherein the (i)th personalized image is associated with one of the (j) nominal image responses, wherein (i) is greater than or equal to 1, wherein (i) is less than or equal to (N), wherein (j) is greater than or equal to 1, wherein (j) is less than or equal to (K);
receiving a selection of one of the (j) nominal image responses; and
comparing the selected nominal image response with the associated nominal image response.

9. An article of manufacture comprising a non-transitory computer readable medium comprising computer readable program code encoded therein to display images on a station comprising a visual display device, a data input device, and a computing device in communication with the display device, the computing device comprising a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1, the computer readable program code comprising a series of computer readable program steps to effect:
selecting an (i)th personalized image for display, wherein (i) is initially set to 1, and wherein (i) is less than or equal to (N);
displaying, using the visual display device:
the (i)th personalized image; and
(j) nominal image responses, wherein (j) is greater than or equal to 1, wherein (j) is less than or equal to (K), wherein the (i)th personalized image is associated with one of the (j) nominal image responses, wherein the associated (j) nominal image response is the correct response; and
receiving, via the data input device, a user response.

10. The article of manufacture of claim 9, wherein the computer readable program code further comprises a series of computer readable program steps to effect setting (i) equal to (i+1) and repeating said selecting, said displaying, and said receiving.

11. The article of manufacture of claim 9, wherein the computer readable program code further comprises a series of computer readable program steps to effect comparing the user response with the correct response.

12. The article of manufacture of claim 11, wherein the computer readable program code further comprises a series of computer readable program steps to effect:
when the user response is the same as the correct response, setting (i) equal to (i+1) and repeating said selecting, said displaying, said receiving, and said comparing; and
when the user response is not the same as the correct response, displaying, on the visual display device, the correct response.

13. The article of manufacture of claim 9, wherein the computer readable program code further comprises a series of computer readable program steps to effect receiving the (i)th personalized image and an associated nominal image response.

14. The article of manufacture of claim 9, wherein the (i)th personalized image is of a future action, wherein the correct response is an affirmation of the occurrence of the future action, wherein the computer readable program code further comprises a series of computer readable program steps to effect when the user response is not received within a predetermined amount of time, providing a reminder.

15. A article of manufacture comprising a non-transitory computer readable medium comprising computer readable program code encoded therein to display images on a station comprising a visual display device, a data input device, and a computing device in communication with the display device, the computing device comprising a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1, the computer readable program code comprising a series of computer readable program steps to effect:
selecting (q) personalized images for display, wherein (q) is less than or equal to (N);
displaying, using the visual display device:
the (q) personalized images; and
(j) nominal image responses, wherein (j) is greater than or equal to (q), wherein (j) is less than or equal to (K), wherein each of the (q) personalized images are associated with one of the (j) nominal image responses;
for each of the (q) personalized images:
receiving, via the data input device, a user response comprising an identification of one of the (j) nominal image responses;
comparing the user response with the associated nominal image response; and
when the user response is the associated nominal image response, setting (i) equal to (i+1) and repeating said selecting, said displaying, said receiving, and said comparing.

16. A computer program product encoded in a non-transitory computer readable medium and useable with a programmable computer processor to display images on a station comprising a visual display device, a data input device, and a computing device in communication with the display device, the computing device comprising a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1, the computer program product comprising computer readable program code which causes the programmable processor:
to select an (i)th personalized image for display, wherein (i) is initially set to 1, and wherein (i) is less than or equal to (N);
to display, using the visual display device:
the (i)th personalized image; and
(j) nominal image responses, wherein (j) is greater than or equal to 1, wherein (j) is less than or equal to (K), wherein the (i)th personalized image is associated with one of the (j) nominal image responses, wherein the associated (j) nominal image response is the correct response; and
to receive, via the data input device, a user response.

17. The computer program product of claim 16, further comprising computer readable program code which causes the programmable processor to set (i) equal to (i+1) and to repeat said computer readable program code which causes the programmable processor to select, to display, and to receive.

18. The computer program product of claim 16, further comprising computer readable program code which causes the programmable processor to compare the user response with the correct response.

19. The computer program product of claim 18, further comprising:
computer readable program code which, when the user response is the same as the correct response, causes the programmable processor to set (i) equal to (i+1) and to repeat said computer readable program code which causes the programmable processor to select, to display, to receive, and to compare; and
computer readable program code which, when the user response is not the same as the correct response, causes the programmable processor to display, on the visual display device, the correct response.

20. The computer program product of claim 16, further comprising computer readable program code which causes the programmable processor to receive the (i)th personalized image and an associated nominal image response.

21. A computer program product encoded in a non-transitory computer readable medium and useable with a programmable computer processor to display images on a station comprising a visual display device, a data input device, and a computing device in communication with the display device, the computing device comprising a processor and a non-transitory computer readable medium in communication with the processor, wherein the computer readable medium has (N) personalized images and (K) nominal image responses stored thereon, wherein each of the (N) personalized images are associated with at least one of the (K) nominal image responses, wherein (N) and (K) are greater than or equal to 1, the computer program product comprising computer readable program code which causes the programmable processor:
to select (q) personalized images for display, wherein (q) is less than or equal to (N);
to display, using the visual display device:
the (q) personalized images; and
(j) nominal image responses, wherein (j) is greater than or equal to (q), wherein (j) is less than or equal to (K), wherein each of the (q) personalized images are associated with one of the (j) nominal image responses;
and
for each of the (q) personalized images:
to receive, via the data input device, a user response comprising an identification of one of the (j) nominal image responses;
to compare the user response with the associated nominal image response; and
when the user response is not the associated nominal image response, to display, on the visual display device, the associated nominal image response.
